(19) United States
(12) Patent Application Publication
(10) Pub. No.: US 2016/0246919 A1
(43) Pub. Date: Aug. 25, 2016

(54) PREDICTIVE OPTIMIZATION OF NETWORK SYSTEM RESPONSE

(71) Applicant: THE REGENTS OF THE UNIVERSITY OF CALIFORNIA, Oakland, CA (US)

(72) Inventor: Hann Wang, Los Angeles, CA (US)

(73) Assignee: THE REGENTS OF THE UNIVERSITY OF CALIFORNIA, Oakland, CA (US)

(21) Appl. No.: 15/027,678

(22) PCT Filed: Oct. 7, 2014
(86) PCT No.: PCT/US2014/059514

§ 371 Date: Apr. 6, 2016

Related U.S. Application Data
(60) Provisional application No. 61/888,295, filed on Oct. 8, 2013.

(51) Int. Cl. G06F 19/12; G06F 19/28; G06N 7/00; G06N 5/04; G06N 99/00

(52) U.S. Cl. CPC G06F 19/12; G06N 5/04; G06N 99/005; G06N 7/005; G06F 19/28

(57) ABSTRACT

A system includes a drug database, a disease gene database, and a network model describing a physiological or biological network. The network model receives drug data from the drug database related to drugs used in an experiment, and receives disease gene data from the disease gene database related to subjects analyzed in the experiment. The network model identifies propagation of drugs and disease through the physiological or biological network from the drug data and the disease gene data, and outputs a set of system response predictors based on the identification of the propagation. The system further includes a predictive module that receives the system response predictors, receives result data related to outcomes of the experiment, and generates a system response model based on the system response predictors and the result data.

### CROSS REFERENCE TO RELATED APPLICATION

This application claims the benefit of U.S. Provisional Patent Application 61/888,295 filed Oct. 8, 2013 to Wang, titled “Predictive Optimization of Network System Response,” the contents of which are incorporated herein by reference in their entirety.

### STATEMENT REGARDING FEDERALLY SPONSORED RESEARCH OR DEVELOPMENT

This invention was made with Government support under Grant No. 0751621, awarded by the National Science Foundation (Edison). The Government has certain rights in the invention.

### BACKGROUND

The pharmaceutical industry generally focuses on the development of targeted drugs based on an assumption that the drug target can be located if the mechanism of the disease-causing pathway is understood. A series of chemical screenings can then be performed to select those drugs that target the molecules inside the disease pathway. Selected drugs from the screenings subsequently are further screened for biological activity in an in vitro model. This type of mechanistic study, the rational design pipeline, may be helpful in the discovery of potential drug targets, but inefficient in introducing satisfactory therapeutic interventions. Further, production cost is greater for a single-target agent versus a cytotoxic agent. Additionally, single-target agents may be less efficient then cytotoxic drugs.

Thus, it would be beneficial to have the capability to predict the outcome of a drug therapy, thereby informing an efficacious therapeutic regimen.

### SUMMARY

In one aspect, a method includes creating a system response model which maps system response predictors to a system response, wherein at least one of the system response predictors is associated with a node or an edge within a network graph. The system response may be a phenotypic trait. In one embodiment, a phenotypic trait is one of a biochemical property, a physiological property, a morphology, a phenology, a behavior, and a product of a behavior. In another embodiment, the phenotypic trait is one of a viability of cell, a growth inhibition of a cell, an expression level of an enzyme, an intellectual quotient (IQ) of an organism, a cell type label, a response of an organism to a drug, and a side effect of a drug.

The network graph may be a biological network graph, which may be one of a genetic network, a protein-protein interaction network, a signaling network, a gene regulatory network, a neuronal network, a food web, a social network, a metabolic network, and a genetic network.

In one embodiment, the system response predictors are organized in a vector, and one of the entries of a vector of predictors may be one of a gene predictor and a drug predictor.

In one embodiment, at least one of the predictors is represented by one of a continuous number or a discrete label, and at least one of the predictors may be represented as a discrete label that is a network centrality, where the network centrality may be one of degree centrality, a betweenness centrality, a bridging centrality, an eigenvector centrality, a closeness centrality, and a Katz centrality. In another embodiment, at least one of the predictors is an environmental factor which influences a phenotypic trait. In a further embodiment, at least one of the predictors is represented as a discrete label that is generated by diffusion in the network graph. In yet a further embodiment, at least one of the predictors is represented as a discrete label that is extracted from one of a PageRank vector and an n-step diffusion vector.

In one embodiment, at least one of the initial predictors representing the subjects are represented by genetic abnormalities, which include DNA sequence variation, DNA copy number variation, gene expression, state of DNA methylation, and microsatellite instability. The genetic abnormalities are measured by, for example, IHC, FISH/CISH, mythylation analysis, microsatellite instability analysis, next generation sequencing, DNA microarray, RNA microarray, or mass spectrometric genotyping. In another embodiment, at least one of the initial predictors of the phenotypes are represented by post translational modifications (PTMs) of proteins, including protein phosphorylation and histone modification.

In one embodiment, at least one of the initial predictors representing the therapeutic agents are represented by the physicochemical properties of the agents.

In one embodiment, the mapping is generated by using a machine learning technique, in which a training data set including a plurality of system response vectors and a plurality of phenotypic outcome pairs are used to fit the mapping. The machine learning technique may include, for example, the use of one or more of a neural network, averaged one-dependence estimators (AODE), Bayesian statistics, case-based reasoning, a decision tree, a Gaussian process, learning automata, instance-based learning, probably approximately correct learning, a kernel method, a perceptron, a support vector machine, a random forest, an ensemble method, ordinal classification, an information fuzzy network, a conditional random field, analysis of variance (ANOVA), linear classifiers, a boosting method, a Bayesian network, and a hidden Markov model.

The system response model may be trained using the training data set, and the trained system response model used to make predictions of the system response. The predictions may be used to find an optimal system response. Alternatively, the trained model may be used for model improvement by automated selection of new training system response predictors.

In another aspect, a system includes a drug database, a disease gene database, and a network model describing a physiological or biological network. The network model receives drug data from the drug database related to drugs used in an experiment, and receives disease gene data from the disease gene database related to subjects analyzed in the experiment. The network model identifies propagation of drugs and disease through the physiological or biological network from the drug data and the disease gene data, and outputs a set of system response predictors based on the identification of the propagation. The system further includes a predictive module that receives the system response predictors, receives result data related to outcomes of the experiment, and generates a system response model based on the system response predictors and the result data.

In one embodiment, at least one of the system response predictors is associated with a node or an edge within a network graph. The network graph may be a biological network graph that is one of a genetic network, a protein-protein interaction network, a signaling network, a gene regulatory network, a neuronal network, a food web, a social network, a metabolic network, and a genetic network.

In one embodiment, at least one of the system response predictors is an environmental factor which influences a phenotypic trait.

In one embodiment, at least one of the system response predictors is represented as a discrete label that is a network centrality, and the network centrality is one of degree centrality, a betweeness centrality, a bridging centrality, an eigenvector centrality, a closeness centrality, and a Katz centrality.

The system response predictors may be organized in a vector, and one of the entries of a vector of predictors is one of a gene predictor and a drug predictor

### BRIEF DESCRIPTION OF THE DRAWINGS

FIG. 1 illustrates an example of a system for system response prediction.

FIG. 2 illustrates a 100-fold cross validation of the prediction techniques of this disclosure.

FIG. 3 illustrates an example of a computing device.

### DETAILED DESCRIPTION

In the prediction technique described in this document, predictions regarding single or multiple drug therapy inform an efficacious therapeutic regimen for treating a disease. System-level data is used to evaluate combinatorial drug efficacy. Structural network information is used, along with multiple targets, such that interaction between drug targets can be taken into account. Information is combined in proteomic scale.

The prediction technique estimates the performance of a formula of drugs given pathogenic traits of a subject. A subject may be, for example, a cell line, or primary cells of a patient. Two inputs are provided, a pathogenic profile of the subject, and a performance of a drug. A pathogenic profile is a molecular level profile which may be represented, for example, by a genetic mutation profile of the subject, by pathologically relevant genes of the subject, or by a protein array data or other information related to pathogenesis. A performance of a drug formula may be determined and represented by an index of efficacy, which can be, by way of example, the area under curve (AUC) of a drug toxicity experiment, the GI50 concentration of a growth inhibition experiment, or the IC50 concentration of a particular drug.

In accordance with the prediction technique, predictions of efficacious uses of existing drugs or drug combinations are generated. Alternatively or additionally, a set of high impact drug or drug combinations is suggested. Further, a description of drugs with associated drug targets may be provided to create or expand a library of drugs.

Diseases, such as cancer, are multigenic in nature, and the diseased state is a result of body system dynamics. Therefore, a global approach is used by considering a multiplicity of resources. Therapeutics are also considered at a system level. A multi-target strategy can introduce possibilities into the treatment regimen by addressing the system from multiple fronts. However, as the number of therapies to consider increases, so also the number of possible combinations to consider increases, and the resulting problem may overwhelm the existing computational resources. The prediction techniques of this disclosure provides a solution for selecting efficacious drug combinations from the many alternatives available. The prediction technique is capable of searching a full drug library, which can include FDA approved drugs, experimental drugs, and bio-related chemicals. A predictive machine predicts the outcome of drugs and drug combinations, which is used to guide an optimization machine for the suggestion of high impact drug combinations.

A cell's response to external stimuli is determined largely by the topology of the biological network, as demonstrated in network pharmacology studies. The prediction technique of this disclosure mines global structural information encoded by the biological network. Specifically, a determination is made for a given selection of disease genes whether their position on a biological network will lead to a predictable result.

An embodiment of the prediction technique is implemented in the “Predictive Optimization of Pharmaceutical Efficacy” (PROPHECY) system, which links the network properties of drugs and the genetic profiles of subjects to the efficacy of a drug combination. PROPHECY is described in portions of this document by way of a non-limiting example.

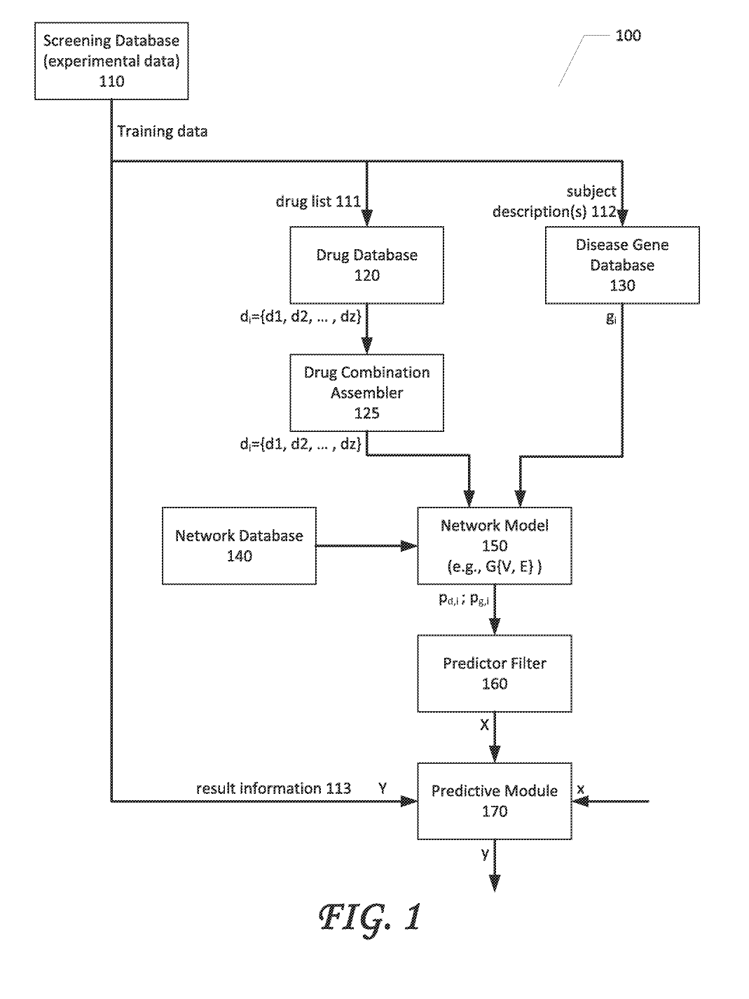

FIG. 1 illustrates a representative depiction of a system 100 including a screening database 110, a drug database 120, a drug combination assembler 125, a disease gene database 130, a network database 140, a network model 150, a predictor filter 160, and a predictive module 170. System 100 is first trained, then may be used for prediction. During training, system 100 determines a prediction model given training data from screening database 110 and given a selected network model 150 from network database 140. The prediction model is a system response model which maps system response predictors to system response.

Examples of system responses include a phenotypic trait, such as a biochemical property, a physiological property, a morphology, a phenology, a behavior, a product of a behavior, a viability of a cell, a growth inhibition of a cell, an expression level of an enzyme, an intellectual quotient (IQ) of an organism, a cell type label, a response of an organism to a drug, and a side effect of a drug.

A predictor may be represented as a discrete label, such as is generated by diffusion in a network graph. Predictors may be organized in a vector, for example a vector including gene predictors and/or drug predictors. Predictors include biological, chemical, genetic, and environmental factors that influence phenotypic traits.

Once a prediction model is created, the prediction model may be used to predict an outcome based on information x related to a subject or subjects under investigation. The prediction model may further be used for model improvement by automated selection of new training system response predictors.

Screening database 110 includes experimental data, which includes experiment conditions such as a drug list 111 used in the experiment, and subject descriptions 112 of subjects observed in the experiment. Experimental data also includes experiment results 113 (labeled Y), such as drug efficacy for a particular mutation. Experimental data may be represented in the same format for each experiment, or later converted to the same format. For example, the AUC of a drug sensitivity assay can be used as an indicator for drug efficacy. The experimental data guides system 100 to find interactions between network nodes of the selected network.

To generate a prediction model, experimental data is selected from screening database 110 to use during training, and the selected experimental data identifies the information that will be used from drug database 120 and disease gene database 130, as follows.

Drug database 120 links various drugs to their targets. The drug list 111 from screening database 110 for a particular experiment or experiments identifies a drug or drugs in drug database 120 to include in the determination of the prediction model. Drug combination assembler 125 links combinations of drugs from drug database 120 to targets.

Disease gene database 130 relates subjects to their genetic profiles. The subject descriptions 112 from screening database 110 for a particular experiment or experiments identifies a subject or subjects to include in the determination of the prediction model.

In addition to the selection of experimental data for determining the prediction model, a network type is selected. Network database 140 provides descriptions of various network types. The network descriptions include, for example, descriptions of protein-protein interaction (PPI) networks which link molecular interactions in a direct or undirected graph format, genetic networks, signaling networks, gene regulatory networks, neuronal networks, food webs, social networks, metabolic networks, and signal transduction networks. In some embodiments, PPI may be used for the edge of the network representing physical interaction, as it is less prone to unexpected interactions stemming from the interpretations of different datasets as may occur using a genetic network. Descriptions in network database 140 may be in the form of network models 150. A prediction model is based on a network model 150 as modified by drug and subject interactions with the network.

During training, mutations of the experimental subject(s) that cause physical changes to a selected network are identified and mapped onto the associated network model 150. The relative impact of the mutation on a target may also be included in the mapping. Also mapped onto the network model 150 are drugs (or drug combinations) with their targets and associated efficacies.

Network model 150 produces a preliminary set of training data based on information from drug combination assembler 125 and disease gene database 130. The training data encodes network and bioactivity information. The quantity of training data typically will be too large for realistic prediction, so the input is passed through predictor filter 160 to filter out low information content data, leaving filtered data X. Predictive module 170 generates an efficacy prediction model from the filtered data X and experiment result information Y (113).

Metrics may be assigned to networks such as the networks described in network database 140. Metrics may include nodal scores which reflect characteristics of a node in relation to the geometry of a network. Metrics may be discrete labels or continuous numbers. For instance, degree centrality is a nodal score that shows how connected a particular node is. Studies have shown that degree centrality, betweenness centrality, and bridging centrality, for example, may be related to how well a node can be used as a drug target. Thus, centralities may be predictors. Other centralities include eigenvector centrality, closeness centrality, and Katz centrality. Interactions between nodes collectively may describe a response of a cell to a treatment. Drug targets are considered, as well as the location of disease nodes.

While the states of cells vary between cells and between individuals, a given network structure is nearly invariant between cells and between individuals. Therefore, a common descriptor language is used to describe the level of impact to a node affected by drug target nodes and/or disease nodes. The common descriptor language is discussed by way of example for a PPI network. Identifiers G{V, E}, Y, g, d, X, x, y, p_{d,i}, p_{g,i}, and dᵢ={d1, d2, . . . , dz} as illustrated in FIG. 1 refer to the PPI network example, and will be discussed below in context.

Disease models in a library such as in gene database 130 are represented as a set of cell lines Γ={gᵢεR^{n×1}|i=1, . . . , N_{c}}, where gᵢ denotes a vector in which non-zero entries of the vector are confidence scores of a disease gene. The confidence score reflects the type of mutation the gene causes. N_{c} is the number of cell lines in the disease model. Disease gene database 130 provides vectors gᵢ for the experiment subject(s).

The set of drugs Ω in a library such as in drug database 120 is represented as a set of drug vectors: Ω={dᵢεR^{n×1}|i=1, . . . , N_{d}}, where dᵢ={d1, d2, . . . , dz} is a vector with at least one nonzero entry being the confidence score(s) associated with the drug targets 1 through z for the drug i, and N_{d} is the number of drugs in the library. An advantage of expressing a drug i as a vector dᵢ is that each drug, and each drug combination, can be expressed in the same format. The prediction technique described in this document needs no knowledge of whether a given drug is a single drug or a combination of drugs. To accommodate the various options, each drug, and each drug combination, is denoted as dᵢ, where i is a representation for the drug or drug combination, and not the indexing of single drugs. Thus, in FIG. 1, the output of both drug database 120 and drug combination assembler 125 is one or more vectors dᵢ. In the case when there are overlaps between drugs, which is common between a family of drugs or non-specific drugs such as cytotoxic drugs, vectors representing the overlapping drugs are combined into a single vector dᵢ by equation 1. In equation 1, the vectors dⱼ represent overlapping drugs.

dᵢ=1−Πⱼ(1−dⱼ) (1)

A PPI network can be represented by a graph G{V, E}(see example given for network model 150 in FIG. 1), where V denotes the set of nodes and E denotes the set of edges, and there are n nodes and k edges in G. An undirected network with an adjacency matrix A may be represented, in which elements of matrix A are as shown in equation 2, and where aᵢⱼ represents a confidence score which links to evidence on this interaction.

$${A}_{ij} = \{ \begin{matrix}{a}_{ij} & if \{ i , j \} ∈ E , \\ 0 & else .\end{matrix} , {a}_{ij} ∈ ( 1 , 0 ) \qquad ( 2 )$$

Scores are calculated for the nodes of G. A personalized PageRank may be used as the nodal score instead of calculating the nodal score of each node as the predictors for the objective function. PageRank is less sensitive to errors in network data, a common problem in network datasets. PageRank is also normalized, so is easier to be used for further processing. Using a random walker approach, a personalized PageRank may be determined, as follows.

Propagation of information from disease genes and drug targets is identified for the selected network to create the prediction model. If there is a lack of detailed network directionality and reaction constants, there may not be a complete picture on how the actual dynamics of the network state will shift due to intervention of drugs and disease genes. However, because the linkage between nodes is known, and it is known that the state of the neighbors of the drugged (or mutated) nodes is distorted, a random walker may be used to further identify the state of the network. The selected network model is transformed to take into account dangling nodes that have one incoming edge. Otherwise, the dangling nodes may absorb most of the random walk probability, and the probability at the dangling nodes will be over-amplified after many iterations. To prevent this outcome, outgoing edges from the dangling nodes are added to other nodes.

The random walker starts from a drugged (or mutated) node to model the propagation of information, based on the assumption that the most affected nodes may be determined by looking at the steady state distribution after the random walker was presented in the network for a long time. The propagation of the random walker will reach a single steady state regardless of the starting nodes, as predicted by the Perron Frobenius Theorem. The theorem states that the stationary distribution of the random walker will converge to an eigenvector of eigenvalue equal to one. To make the starting nodes matter, the random walker is used with restart. By putting the random walker back to the original node(s), the converged distribution will be analogous to a personalized PageRank.

To model the random walk, a state transition matrix is defined as W=D⁻¹A, where D is the degree matrix. To evaluate the effect of mutated nodes on the network, the random walk initial distribution is set as

$${p}_{g , i}^{0} = \frac{{g}_{i}}{{\vert {g}_{i} \vert}_{1}} ,$$

and the same normalization with taxicab norm can be applied to drugged nodes. For any initial distribution p⁰, the random walk process may be modeled as p^{t+1}=(1−r)Wp′+rp⁰, where r is the teleportation constant. The steady state probability p^{∞} is an evaluation of how one subset of nodes affects the nodes in the whole network. The steady state probability p^{∞} is the solution of p^{∞}=(1−r)Wp^{∞}+rp⁰. Thus, the solution of the PageRank for a given initial distribution is p^{∞}=r(I−(1−r)W)⁻¹p⁰.

The information propagation for a given initial probability distribution p_{g,i}⁰ and p_{d,i}⁰ is calculated for the network model 150. In the later fitting stage, the initial distribution is not used, and instead steady state distribution is used. Thus, the superscript ∞ is removed, and p_{g,i} and p_{d,i} denote a steady state distribution.

Given the large dataset and nonlinear interactions in network data, machine learning techniques are used to aid in prediction, and corresponding machine learning terminology is used for simplicity. To illustrate the predictive power of a system such as PROPHECY, a common index AUC for the sensitivity of cell line to a drug is used, as described below. For a continuous value such as AUC, regression analysis may be used to relate the predictors to the output. However, the prediction provided by system 100 is not limited to regression, but rather may include other techniques such as the use of a support vector machine, a Gaussian process, a logistic regression, a linear regression, a neural network, a kernel estimator, a multilinear subspace learning, a naïve Bayes classifier, or ensembles of classifiers. Network information extracted from the framework of system 100 may also make categorical predictions, such as the side effect of a drug combination.

Predictor filter 160 assembles the probability distributions p_{g,i} and p_{d,i} into a design matrix X from a set of m data points, as shown in equation 3.

$$X = ( \begin{matrix}{p}_{g , 1}^{T} & {p}_{d , 1}^{T} & 1 \\ {p}_{g , 2}^{T} & {p}_{d , 2}^{T} & 1 \\ ⋮ & ⋮ & ⋮ \\ {p}_{g , m}^{T} & {p}_{d , m}^{T} & 1\end{matrix} ) \qquad ( 3 )$$

The last column of ones is introduced for the fitting of an intercept at a later regression step. As the column of ones causes excess predictors to be included, a cutoff probability is introduced to discard those columns where there is no probability larger than the cutoff. The remaining portion of matrix X is a set of system response predictor vectors that may be used for training, and the discarded columns of matrix X also form a matrix that may be used for training.

Predictive module 170 generates output y from training information Y related to experiment results for the selected experiment(s), as received from screening database 110. For example, output y may be one or more of phenotypic output pairs. Output y may be transformed for better fitting. The range of y is within [0, 1], and may be transformed to another range, such as [−∞, ∞]. For example, a sigmoidal transformation is introduced, such that output y is as shown in equation 4, where ŷ is the transformed output, and γ is a shape factor that describes the sigmoidal curve.

$$y = \frac{1}{{( 1 + exp ( - \hat{y} ) )}^{γ}} \qquad ( 4 )$$

The transformed output may then be assembled as an output vector, as shown in equation 5.

y=[ŷ₁,ŷ₂, . . . ,ŷₘ]^{T} (5)

Having determined the design matrix of predictors X (based on training information from screening database 110 related to experiment subjects and drugs) and the output vector y (based on training information Y from screening database 110 related to experiment results), system 100 proceeds to find a mapping between X and y.

Predictive module 170 uses, in one embodiment, a Gaussian process with polynomial kernel to find a mapping between X and y. An assumption is made that output y is a noisy version of an original mapping, so that y=f(x)+ε, where ε is an additive independent identically distributed Gaussian noise with variance σₙ².

The predictive mean for a set of test inputs X is shown in equation 6.

f_{∞}≡E[f_{∞}|X,y,X,]=K(Xₓ,X)[K(X,X)+σₙ²I]⁻¹y (6)

A polynomial kernel is used to ensure that the nodes have global influence on the response, as shown in equation 7, where the hyperparameter p is the order of polynomial, and can be optimized at a model selection stage.

k(x,xₓ)=(1+x^{T}xₓ)^{p} (7)

### Validation

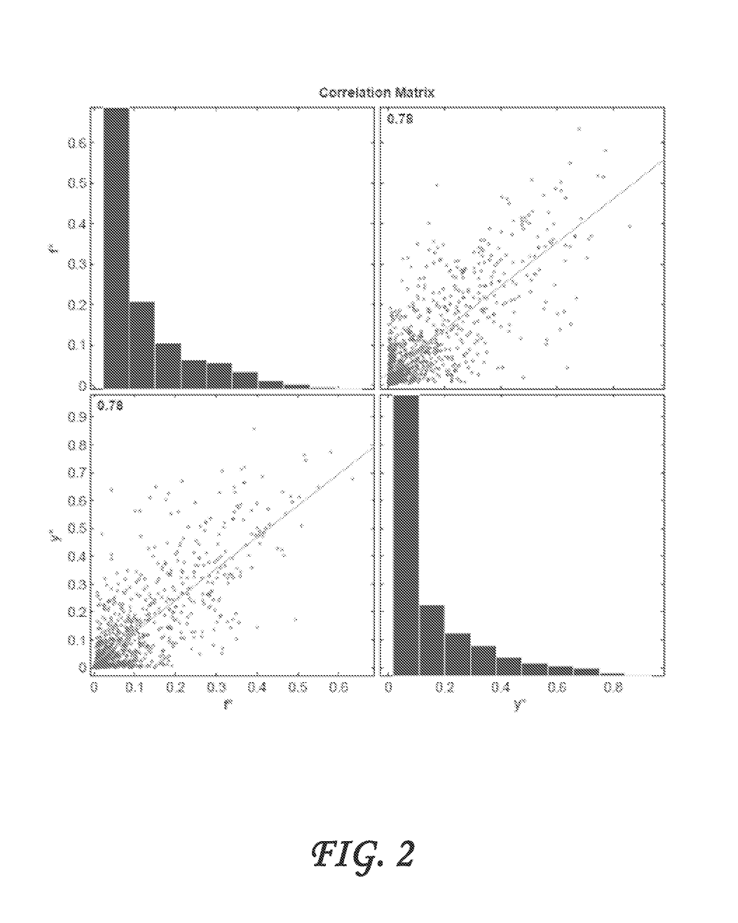

A 100-fold cross validation was performed to fit the results from a COSMIC dataset, and the correlation for the prediction and actual experimental result was 78%, as shown in FIG. 2. This indicates that the efficacy was explained at least 60% by the predictors. This level of accuracy can significantly improve the current inability to generate a drug combination library, and provides medical researchers a global index for estimation of drug combination efficacy.

Accuracy of the prediction may be improved, for example, by adding more predictors, such as the physical properties of drugs and state information of cells; by improving the quality of the network data, as there are many false positives in the current PPI databases; improving the quality of experimental results; and by further optimizing the hyperparameters. Examples of optimizing hyperparameters include tuning the teleportation constants in pageRank to affect the influence of initial nodes, and modifying shape factor, γ, to influence the transformation and subsequent fitting. Accuracy of the prediction may be further improved, for example, by selecting a fitting other than the Gaussian process with polynomial kernel as described.

To understand challenges faced in optimizing a drug combination, it is helpful to have a sense of how fast f can be evaluated. The operation involves the multiplication of a Gram matrix and a multiplication of the inverse matrix. The inverse matrix of the training set may be computed beforehand. The multiplication of the Gram matrix may take an enormous number of operations, which may not be practical for available computational resources. The calculation task of finding a theoretically preferred drug combination can be posed instead as an optimization problem, as in equation 8.

$${x}_{*} = {argmin}_{{x}_{*}} {K ( {x}_{*} , X ) [ K ( X , X ) + {σ}_{n}^{2} I ]}^{- 1} y \qquad ( 8 )$$

Equation 8 can be solved by using a regular conjugate gradient solver. Note that this equation can be further expanded to include terms that account for drug toxicity and side effects. Additionally, other cell lines can be included by adding terms. The prediction is powerful in assisting decision making. The optimized distribution is used to back-calculate the initial condition for the drug as

$${p}_{*}^{0} = \frac{1}{r} [ I - ( 1 - r ) W ] {p}_{*}^{∞} ,$$

where pₓ^{∞} is the recovered PageRank from xₓ after the rest of the nodes are filled with equal probability, and pₓ⁰ is the initial distribution.

With the theoretical distribution of optimal drug combination, a set of single drugs can be found to match the profile. Now, the problem is translated into profile matching. For profile matching, the goal is to minimize the difference between a predictive distribution pₓ⁰, and an assembled distribution p_{d}⁰ from the drug library. The drug combination is assembled as shown in equation 9, and aᵢ is introduced to do the selection of the drug.

$$d = 1 - {\prod }_{i}^{ } ( 1 - {a}_{i} {d}_{i} ) , where {a}_{i} ∈ [ 0 , 1 ] \qquad ( 9 )$$

The translation from d to p_{d}⁰ is similar to the translation shown in equation 10 for p_{g,i}⁰.

$${p}_{g , i}^{0} = \frac{{g}_{i}}{{\vert {g}_{i} \vert}_{1}} \qquad ( 10 )$$

The problem of matching is a problem of optimization, expressed as in equation 11, where ‘a’ has the same number of entries as the number of drugs N_{d} in the drug library.

$$a = {{argmin}_{a} ( {p}_{*}^{0} - {p}_{d}^{0} ( a ) )}^{2} \qquad ( 11 )$$

By solving equation 11 with a regular optimization solver, a preferred combination can be found that satisfies criteria related to clinical objectives.

While certain conditions and criteria are specified herein, it should be understood that these conditions and criteria apply to some embodiments of the disclosure, and that these conditions and criteria can be relaxed or otherwise modified for other embodiments of the disclosure.

While the disclosure has been described with reference to the specific embodiments thereof, it should be understood by those skilled in the art that various changes may be made and equivalents may be substituted without departing from the true spirit and scope of the disclosure as defined by the appended claims. In addition, many modifications may be made to adapt a particular situation, material, composition of matter, method, operation or operations, to the objective, spirit and scope of the disclosure. All such modifications are intended to be within the scope of the claims appended hereto. In particular, while certain methods may have been described with reference to particular operations performed in a particular order, it will be understood that these operations may be combined, sub-divided, or re-ordered to form an equivalent method without departing from the teachings of the disclosure. Accordingly, unless specifically indicated herein, the order and grouping of the operations is not a limitation of the disclosure.

An embodiment of the disclosure relates to a non-transitory computer-readable storage medium having computer code thereon for performing various computer-implemented operations. The term “computer-readable storage medium” is used herein to include any medium that is capable of storing or encoding a sequence of instructions or computer codes for performing the operations, methodologies, and techniques described herein. The media and computer code may be those specially designed and constructed for the purposes of the embodiments of the disclosure, or they may be of the kind well known and available to those having skill in the computer software arts. Examples of computer-readable storage media include, but are not limited to: magnetic media such as hard disks, floppy disks, and magnetic tape; optical media such as CD-ROMs and holographic devices; magneto-optical media such as optical disks; and hardware devices that are specially configured to store and execute program code, such as application-specific integrated circuits (“ASICs”), programmable logic devices (“PLDs”), and ROM and RAM devices.

Examples of computer code include machine code, such as produced by a compiler, and files containing higher-level code that are executed by a computer using an interpreter or a compiler. For example, an embodiment of the disclosure may be implemented using Java, C++, or other object-oriented programming language and development tools. Additional examples of computer code include encrypted code and compressed code. Moreover, an embodiment of the disclosure may be downloaded as a computer program product, which may be transferred from a remote computer (e.g., a server computer) to a requesting computer (e.g., a client computer or a different server computer) via a transmission channel. Another embodiment of the disclosure may be implemented in hardwired circuitry in place of, or in combination with, machine-executable software instructions.

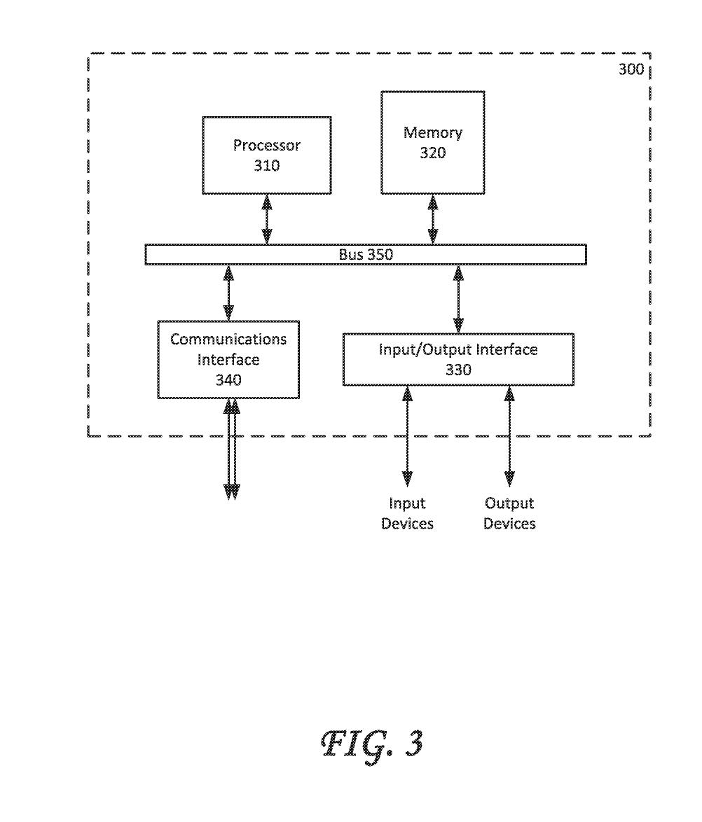

Computer code may be executed by a processor in a computing device, such as a processor in a computer, desktop computer, mobile device, server or other computing device. FIG. 3 illustrates an example of a computing device 300 that includes a processor 310, a memory 320, an input/output interface 330, and a communication interface 340. A bus 350 provides a communication path between two or more of the components of computing device 300. The components shown are provided by way of illustration and are not limiting. Computing device 300 may have additional or fewer components, or multiple of the same component.

Processor 310 represents one or more of a processor, microprocessor, microcontroller, ASIC, and/or FPGA, along with associated logic.

Memory 320 represents one or both of volatile and non-volatile memory for storing information. Examples of memory include semiconductor memory devices such as EPROM, EEPROM and flash memory devices, magnetic disks such as internal hard disks or removable disks, magneto-optical disks, CD-ROM and DVD-ROM disks, and the like.

The prediction technique described in this disclosure may be implemented as computer-readable instructions in memory 320 of computing device 300, executed by processor 310.

Input/output interface 330 represents electrical components and optional code that together provides an interface from the internal components of computing device 300 to external components. Examples include a driver integrated circuit with associated programming.

Communications interface 340 represents electrical components and optional code that together provides an interface from the internal components of computing device 300 to external networks.

Bus 350 represents one or more interfaces between components within computing device 300. For example, bus 350 may include a dedicated connection between processor 310 and memory 320 as well as a shared connection between processor 310 and multiple other components of computing device 300.

1. A method comprising:
in a computing device, creating a system response model which maps system response predictors to a system response, wherein at least one of the system response predictors is associated with a node or an edge within a network graph.

2. The method of claim 1, wherein the system response is a phenotypic trait, and the phenotypic trait is one of a biochemical property, a physiological property, a morphology, a phenology, a behavior, a product of a behavior, a viability of cell, a growth inhibition of a cell, an expression level of an enzyme, an intellectual quotient (IQ) of an organism, a cell type label, a response of an organism to a drug, and a side effect of a drug.

3. The method of claim 1, wherein the network graph is a biological network graph.

4. The method of claim 3, wherein the biological network graph is one of a genetic network, a protein-protein interaction network, a signaling network, a gene regulatory network, a neuronal network, a food web, a social network, a metabolic network, and a genetic network.

5. The method of claim 3, wherein at least one of the system response predictors is represented as a discrete label that is generated by diffusion in the network graph.

6. The method of claim 3, wherein at least one of the system response predictors is represented as a discrete label that is extracted from one of a PageRank vector and an n-step diffusion vector.

7. The method of claim 1, wherein at least one of the system response predictors is an environmental factor which influences a phenotypic trait.

8. The method of claim 1, wherein at least one of the system response predictors is represented as a discrete label that is a network centrality, and the network centrality is one of degree centrality, a betweeness centrality, a bridging centrality, an eigenvector centrality, a closeness centrality, and a Katz centrality.

9. The method of claim 1, wherein the system response predictors are organized in a vector, and one of the entries of the vector of predictors is one of a gene predictor and a drug predictor.

10. The method of claim 1, wherein the mapping is generated by using a machine learning technique, in which a training data set including a plurality of system response vectors and a plurality of phenotypic outcome pairs are used to fit the mapping.

11. The method of claim 10, wherein the model is trained using the training data set, and the trained model is used for model improvement by automated selection of new training system response predictors.

12. The method of claim 10, wherein the machine learning technique includes the use of one of a neural network, averaged one-dependence estimators (AODE), Bayesian statistics, case-based reasoning, a decision tree, a Gaussian process, learning automata, instance-based learning, probably approximately correct learning, a kernel method, a perceptron, a support vector machine, a random forest, an ensemble method, ordinal classification, an information fuzzy network, a conditional random field, analysis of variance (ANOVA), linear classifiers, a boosting method, a Bayesian network, and a hidden Markov model.

13. The method of claim 10, wherein the model is trained using the training data set, and the trained model is used to make predictions of the system response.

14. The method of claim 13, wherein the predictions are used to find an optimal system response.

15. A system comprising:
a drug database;
a disease gene database;
a network model describing a physiological or biological network, the network model configured to
receive drug data from the drug database related to drugs used in an experiment;
receive disease gene data from the disease gene database related to subjects analyzed in the experiment;
identify propagation of drugs and disease through the physiological or biological network from the drug data and the disease gene data; and
output a set of system response predictors based on the identification of the propagation; and
a predictive module configured to
receive the system response predictors;
receive result data related to outcomes of the experiment; and
generate a system response model based on the system response predictors and the result data.

16. The system of claim 15, wherein at least one of the system response predictors is associated with a node or an edge within a network graph.

17. The system of claim 16, wherein the network graph is a biological network graph that is one of a genetic network, a protein-protein interaction network, a signaling network, a gene regulatory network, a neuronal network, a food web, a social network, a metabolic network, and a genetic network.

18. The system of claim 15, wherein at least one of the system response predictors is an environmental factor which influences a phenotypic trait.

19. The system of claim 15, wherein at least one of the system response predictors is represented as a discrete label that is a network centrality, and the network centrality is one of degree centrality, a betweeness centrality, a bridging centrality, an eigenvector centrality, a closeness centrality, and a Katz centrality.

20. The system of claim 15, wherein the system response predictors are organized in a vector, and one of the entries of the vector of predictors is one of a gene predictor and a drug predictor.
